(19) United States
(12) Patent Application Publication
(10) Pub. No.: US 2013/0085828 A1
(43) Pub. Date: Apr. 4, 2013

(54) SYSTEM AND METHODS FOR CONTENT DISTRIBUTION WITH INTEGRATED GAME MECHANICS

(71) Applicant: Andrew Michael Schuster, Baltimore, MD (US)

(72) Inventor: Andrew Michael Schuster, Baltimore, MD (US)

(21) Appl. No.: 13/645,065

(22) Filed: Oct. 4, 2012

Related U.S. Application Data
(60) Provisional application No. 61/543,178, filed on Oct. 4, 2011.

(51) Int. Cl. G06Q 30/02

(52) U.S. Cl. 705/14.25; 705/14.39

(57) ABSTRACT

Methods and systems provided can incentivize consuming, sharing, and interacting with online content by providing redeemable points to users for their interaction with content. Points may be redeemed for real or virtual goods and services. Profiles on social networking websites relating to users or their social circles can be mined using natural language processing to determine topical interests relevant to users to facilitate displaying online content most likely to be of interest to users.

### CROSS-REFERENCE TO RELATED APPLICATIONS

This application claims priority to U.S. provisional application Ser. No. 61/543,178 filed Oct. 4, 2011, entitled “System and Methods for Content Distribution with Integrated Game Mechanics,” which is incorporated herein by reference in its entirety

### TECHNOLOGY FIELD

The present invention relates generally to systems and methods for delivering content online, and more particularly to systems that encourage interaction with online content by providing incentives for certain activities, such as consumption and sharing of content items.

### BACKGROUND

Traditionally, content on the Internet has been delivered by allowing users visiting individual sites in a piece-meal fashion, allowing a user to pick and choose the sites he wants to visit. Often, websites generate traffic to their content by using ads, which may be expensive. In recent years, aggregators have become available that allow users to view the content of multiple sites, often in a single dashboard layout. Aggregators, such as RSS feed aggregators, allow content distributors to make individual articles, such as news articles or blog entries available to be distributed or made available automatically to any users that subscribe to feeds. Until recently, however, content aggregation and distribution has been driven by individuals searching for and subscribing to specific content unique to that individual's interests.

An aggregator can include computer software or websites aggregate news from other news sources, such as blogs and news websites. An aggregator may be used with a desktop computer, laptop, or mobile device. The rise of mobile devices has presented a relatively new opportunity to enable developers to create engaging interfaces and curate content for individuals from web sources. Many traditional print and web publishers now rely on aggregators as both content distribution outlets and marketing channels. Aggregators may be an effective distribution outlet, but their use is limited by the initiative of an individual to seek out the content of aggregation streams. Loyalty for individual users is limited by their desire to consume the content published and received by their aggregator. A user's exposure to content may be limited to a few content streams that he subscribes to, and he may not be aware of other content streams that match his interests. Aggregators have also been traditionally limited to news and certain websites that publish individual content on a regular basis.

With the recent rise of social media, content distributors may have another way to distribute content individuals. A user may share an article with other members of his social circle using social media sites, such as Twitter and Facebook. This may allow an individual to share individual news items or blog articles with his friends more easily. However, like aggregators, sharing on social media is limited by the desire of an individual to share an individual article or item with his social circle.

Accordingly, there is a need for encouraging users to consume and share content and/or make content discovery and delivery easier and more meaningful.

### SUMMARY

Embodiments of the present invention address and overcome one or more of the above shortcomings and drawbacks, by providing devices, systems, and methods for distributing content to users that based on the interests of the users and providing rewards-based incentives for consuming, sharing, or otherwise interacting with the content. This technology is particularly well-suited for, but by no means limited to software and computing devices that aggregate news or media feeds and distribute content to users based on the users' social media profile information, while providing redeemable point-based incentives for users to consume, share, or interact with the content items they receive.

Some embodiments of the present invention are directed to a method of incentivizing user consumption of content in an online environment, including steps of automatically selecting, by a processor on at least one server, content items to display to a user and sending the selected content items across a network to display the content items to the user. In response to user interaction with the content items, a server may associate reward point values with the user on the at least one server. The server receives a plurality of offers and allows a user to redeem reward point values for incentives identified by at least one of the plurality of offers.

According to one aspect of these embodiments, the step of automatically selecting content items may include comprises steps of receiving information about the category of content contained in each content item at the at least one server and comparing the category to stored information about a user's interest in the category of content. According to another aspect, a processor may generate the stored information about a user's interest by applying natural language processing to a user's profile information on at least one social networking website. According to another aspect, the social networking website can be Facebook and the profile information comprises at least one of the user's Facebook profile and the user's posts to Facebook.

In yet another aspect of some embodiments, a processor may generating the stored information about a user's interest by applying natural language processing to profile information at least one social networking website. The profile information can include at least one of posts and profile information of other users associated with the user. The other users can share a social circle with the user, as determined by the profile information.

According to another aspect of these embodiments, user interaction can include sharing at least one content item using a social networking website, playing a game related to the content of at least one content item. This game may include a trivia game that poses questions to the user to determine his comprehension of the content. In some embodiments, trivia questions may be automatically generated by analyzing the contents of a content item using a natural language process or generated by crowdsourcing, allowing users to create questions after reviewing the content.

Some embodiments of the present invention are directed to a method for distributing content to a user, including receiving, at a server, profile information relating to at least one user, wherein the profile information contains information related to at least one social media profile of the user and automatically analyzing the profile information using natural language processing to determine a first set of topics that relate to the at least one social media profile of the user. The method then performs steps of matching, at the server, the first set of topics to a second set of topics associated with a set of content items to determine a set of relevant content items, transmitting at least a subset of the relevant content items to an electronic device for display to the user, and automatically rewarding the user for select interactions with the subset of the relevant content items in the form or redeemable reward points.

According to one aspect of these embodiments, profile information contains information related to at least one social media profile of the other users in a social circle with the user. According to another aspect of some embodiments, the step of automatically analyzing the profile information includes identifying frequently occurring words is the profile information that is associated with topical categories. According to another aspect of some embodiments, steps further include maintaining a database with at least one record for each user that includes the first set of topics associated with each user. According to another aspect of some embodiments, steps further include monitoring the user's interaction with the subset of the relevant content items to determine user behavior patterns and using the behavior patterns to automatically update the first set of topics associated with the user to reflect the topics that the user interacts with the most.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a plurality of views of exemplary user interfaces for use with some embodiments;

FIG. 2 is a view of an exemplary user interface for use with some embodiments;

FIG. 3 is a system diagram of an exemplary embodiment of a content delivery and incentive system;

FIG. 4 is a system diagram of an exemplary embodiment of a content delivery and incentive system;

FIG. 5 is a flow chart of an exemplary method for distributing content and rewarding users for interaction with content for use with some embodiments; and

FIG. 6 is a flow chart of an exemplary method for distributing content and rewarding users for interaction with content for use with some embodiments.

### DETAILED DESCRIPTION OF ILLUSTRATIVE EMBODIMENTS

Embodiments of the present invention have addressed certain problems in prior art by providing incentives for users to consume and/or share content. A first way that some embodiments may encourage consumption and sharing of content is by using rewards-based incentives, which may be part of a game.

One way that users may be encouraged to consume and interact with content is the use of a news game. News games may include games that apply journalistic principles to the creation of the game. They may fall into multiple categories, including current events, documentaries, simulations of systems, and puzzles. This genre of game is usually based on real concepts, issues, or stories. In some embodiments, games can also offer players a fictional experience based on real-world sources. In some embodiments, users are incentivized to consume and interact with content, by providing a means by which reading the news (or consuming any content) becomes a game for users. In some embodiments, the reward for playing the game or performing well when playing may include rewards that have real, redeemable value.

In some embodiments, a learning-based game may be used to encourage consumption or interaction with Web content. As used herein, web content includes any content that a publisher wishes users on the web to consume. This may include news articles, blog entries, and, in some embodiments, advertisements for products, services, discounts, or the like. In some embodiments, content may include video or audio content. In some embodiments, content may be largely text driven, such as articles.

In some embodiments, a learning-based game may reward users for consuming or interacting with content. In some embodiments, the game may include subliminal learning and an increase in reading comprehension by providing trivia-based game mechanics about the content, such as news, that the user is consuming Traditionally, where a user reads and or shares an article, the user may not fully comprehend the subject matter. In some embodiments, a game-based approach is used to provide game mechanics centered around consumption and comprehension of content. In some embodiments, trivia games are integrated with the delivery of content. Users can be rewarded for reading content, sharing content with friends (such as by e-mailing links, or sharing links on social media websites, such as Facebook), or for their performance in trivia games or other games related to the content consumed.

In some embodiments, an Internet system is used to distribute web-based content and location-based coupons, and to reward users with points for their specific interactions with the content. These points may have redeemable value for a variety of goods and services.

Content can be distributed to a user in a manner that determines which content is suited for each user. This can include a user's aggregator subscriptions, as well as matching content to his interests. In some embodiments, data about content that may be of interest to a user can be drawn from user search, contextual selection, or behavioral analysis of a user to provide meaningful, relevant content and insight. User search can include reviewing the keywords that a user selects when searching for content within the system or by receiving this information from other webpages, such as search engines. Contextual selection can include allowing a user to configure his likes and dislikes. When a user logs into the system to review content, his likes and dislikes can be reviewed from his user configuration file. Behavioral analysis can analyze which content a user has selected in the past, such as his browsing history within the system, or by analyzing the user's behavior when presented with a variety of choices. For example, a user may be presented with various articles when he logs on. The user may choose certain types of articles over others. His selection can provide valuable insight into his likes and dislikes, allowing the system to influence the selection of content based on the user's choices. In some embodiments, user behavior can be analyzed to create a set of data points associated with the user's interests and behaviors. Based upon the accrual of information via user's actions, interactions, customizations and general use of the system, the system may provide a clear picture into who, what, when, how, and why users behave. This information can be mined to improve the system or to lend unique insights into a user's interests and to tailor content or ads to each user.

Once data about a user has been gathered, the data can be used to create a unique experience for each individual user. Content can be categorized by topic and associated with a user's topical interests or filtered based on those interests, as explained herein.

In some embodiments, a content delivery and incentive system can provide a simple, meaningful, and user-centric experience. A user can log on to the platform and find specific content by searching, subscribe to aggregation feeds, or receive feeds from social media, such as by receiving a notification when another user subscribes to a content feed or shares a specific link to a specific article or specific content. These other users can include an individuals user's social circle, such as Facebook friends, Twitter followers, Google+ circle members, or individuals that send messages directly to a user (such as texts or emails). In some embodiments, an individual can make an identification of the content he consumes publicly available. Other users can subscribe to a feed that identifies the content being consumed by that individual. For example, two users may have similar interests. When an individual reviews certain articles, other users that share common interests or who have identified that individual can subscribe to a feed of the articles being consumed by the individual.

In some embodiments, users can be associated by location. For example, where users log into the system on a mobile device, GPS location services on the mobile device can identify the location of each individual. In some embodiments, based on user location using mobile GPS, the system can provide localized reviews, check-in offers, and specials pertinent to his customized preferences in conjunction with his current positioning. In some embodiments, when an individual consumes content, such as reading an article or using a coupon at a local vendor, other users that are geographically close to that individual can receive notification that the individual consumed the content. For example, a user can cash in a deal for a discount on ice cream. Other users (or friends) down the street can receive notification that that user used the ice cream coupon. This can encourage these users to also take advantage of the ice cream discount.

In some embodiments, a user may receive content based on other bases such as contextual selection, user search, or behavioral analysis.

In some embodiments, users can select specific content feeds according to their personal preferences. For example, a user may subscribe to content from certain websites, such as ESPN.com or NewYorkTimes.com, and information from specific vendors, such as coupons and sales, published by a local Mexican restaurant.

Some embodiments can further provide incentives for specific interactions. Users can be rewarded for sharing and publishing the content they consume by paying each user in points that have redeemable value. These points may be provided for each individual action (e.g., each time a user shares an article with his Facebook friends or those friends click the shared link) or may be rewarded for certain milestones (e.g., every 10 articles shared or every 10 times a user's friend clicks on the shared link). Points rewarded can be redeemable for virtual or real goods and services. Users can earn points for interaction based on digital actions or physical actions, such as using a coupon at a store. In some embodiments, points may be redeemed for virtual goods or applications. For example, points may be used to download additional apps for a phone or to download artwork that may be used to customize a user's interface with the system (e.g., avatar accessories or virtual status symbols). In some embodiments, points may also have physical value, allowing users to purchase coupons or vouchers for real-world goods and services. In some embodiments, points may be directly redeemed for goods and services that may be delivered to a user. Goods and services may include merchandise, promotional offerings, or any other desired goods or services.

In some embodiments, the points may be redeemed to participate in limited offers. Limited offers may limit who, when, or where a user may redeem points for the offer. For example, an offer may be presented to a user for a limited period of time or based on a user's current location. For example, after acquiring a certain number of points, a user may be notified that he can redeem his points for a free ice cream cone when he is near an ice cream shop. This can allow local vendors to benefit from the incentives provided to a user based on the content he consumes. In some embodiments, the discount or offers that may be presented to a user may be based on his preferences. For example, if a user likes fashion, fashion discounts and offers may be presented to a user when he logs on the system. Accordingly, local businesses, web businesses, major brands, and content publishers can all benefit from some embodiments of a content delivery and incentive system.

As used herein, natural language processing is the process by which some embodiments can analyze full English sentences, parse out the parts of speech, vocabulary and inflection and determine a weight in order to categorize the sentence. Sentences can come from various sources including a dictionary database or from the context of articles or social sources. In some embodiments, natural language processing allows organically determining what topics are of interest to a user. Organic can mean that a system does not need predefined lists of topical categories. The categories/topics can be determined by user popularity.

As used herein, social data can include a combination of information from social networking sources, such as Facebook likes, wall posts, tweets, Linked/In status updates, Facebook status updates, Facebook interests, person definitions of twitter followers. A person definition can be a data set that associates a few categories (which may include organic categories) to a person, so that if a user likes or follows a person via a social networking website, some embodiments can note the association and associate the interests of those people a user follows or likes with the user himself. For examples, a person definition may include a user and his topical categories of interest, as well as the other individuals he follo-ws or his friends. The interests of those friends or followed individuals can also be associated with the user.

A system for delivering content to users and incentivizing interaction with that content can include two thematic components: A content delivery system selects content to be delivered to users, while an incentive system rewards user interaction with content.

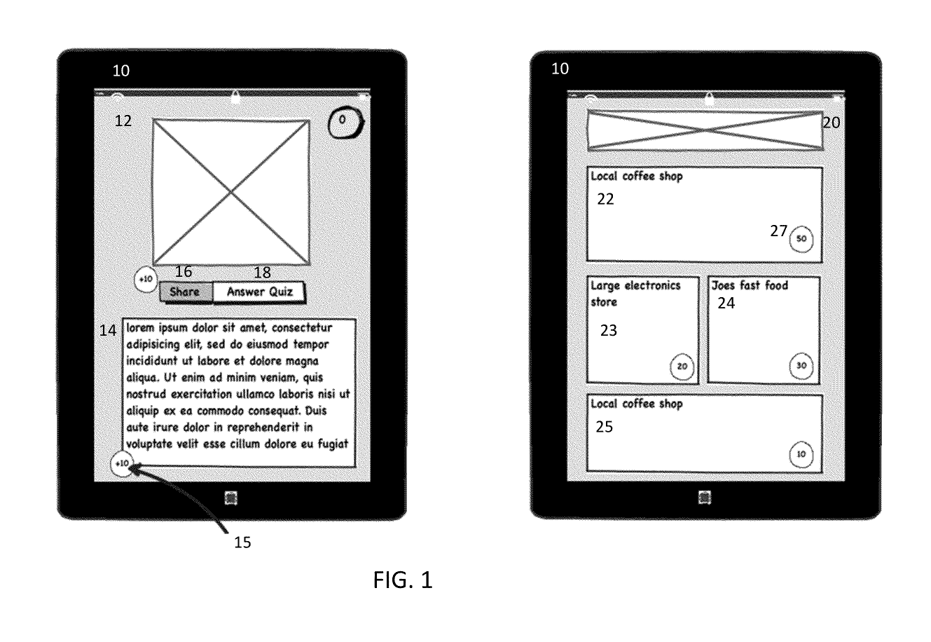

FIG. 1 shows exemplary user interfaces that may be presented to a user to encourage the user to interact with content. A user may view content on a device, such as mobile device 10. Mobile device 10 may be a tablet, laptop, cell phone, etc. In some embodiments, the device used to access the content system may be any Web-enabled computer, such as a PC. These devices include memory, processor, and a network connection that allows the device to access a web-based system across the Internet. A user may be presented with a first user-interface 12 that delivers specific content to the user. This can include displaying an article responsive to a user's search for interests. Content item 14 may include audio, video, or text that a user wishes to view. A content item can include a single piece of content, such as a webpage, news article, offer, blog entry, or the like.

To incentivize user consumption of the content, point scores can be associated with interactions within the content. For example, point value 15 may be associated with a user's reading of the content. Points 15 may be earned by users by reading the content. Mobile device 10 can include an app that determines how long a user spends with the content displayed or the amount of the content through which a user has scrolled. If a user displays the content for a threshold amount of time or reaches the bottom of the page, the user may be awarded points 15.

The user may also be rewarded for certain interaction with the content including sharing the content or demonstrating comprehension of the content, such as by answering a short quiz about the content. User may be awarded a point incentive for clicking a share button 16. This share button may be associated with social networking sites to which the user subscribes. This may advertise the content to the user's friends or social network, encouraging other users to view the content. In this way, a user is provided a direct incentive for advertising content in a viral manner. This may reduce the overall advertising costs associated with the publishers of content, as they can reach a broader audience without purchasing traditional keywords in the search engines. Similarly, a user may be rewarded by clicking a quiz button 18. The user may then be asked to play a game or answer trivia questions related to the content. If a user demonstrates comprehension of the content, the user may be rewarded with points.

Interface 20 may be displayed on device 10 to allow a user to redeem points earned when viewing content, such as points earned by interacting with interface 12. Exemplary rewards that can be obtained by redeeming points include discounts or coupons that may be redeemable for discounts on goods or services, such as discounts 22, 23, 24, or 25. These discounts may have a point value price and allow a user to redeem points for real-world incentives. For example, a free cup of coffee at a local coffee shop may cost a point total identified by value 27.

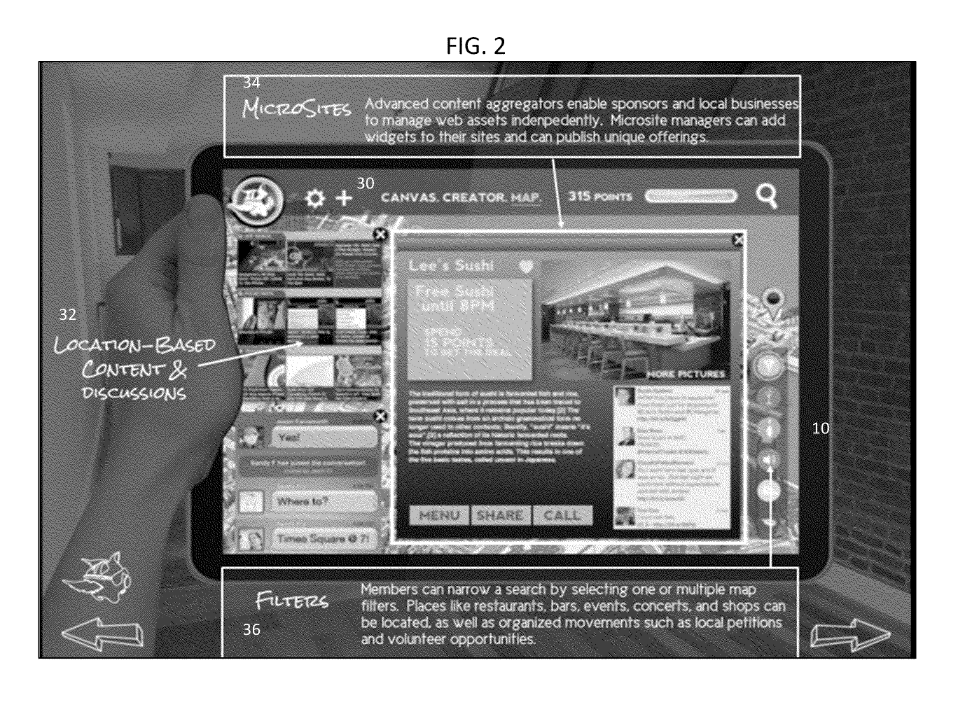

FIG. 2 shows an exemplary screen shot for user interface 30 that may be presented to a user of a content delivery and incentive system. In one section 32 on the screen of mobile device 10, location-based content and discussions may be displayed. This may include reviews or local discounts that are relevant to user's current location. For example, reviews or advertisements for local businesses may be provided as content to a user, for which the user may receive points for viewing. For example, reviewing the menu of a local sushi restaurant may reward a user with points that may be redeemable for any offer, including discounts at that sushi restaurant. Section 32 may also provide a list of available content or rewards that a user may view. In some embodiments, this information is based on the user's location. In some embodiments, this information is based on a user's preferences or interests.

A central section 34 can provide an interface for viewing individual content, such as micro-sites for local businesses, news articles, reviews, etc. The user may be rewarded for interacting with content displayed in section 34. In some embodiments, section 34 displays a webpage to a user. In some embodiments, user-interface 30 is a webpage. The content displayed in section 34 may utilize content aggregators to enable sponsors and local businesses to manage web assets independently. Micro-site managers can add widgets to their sites and publish unique offerings. Widgets may allow a business to publish content that includes links to offers that may be redeemed by a user. In some embodiments, these offers may be paid for by using points that a user has accrued from his past interaction with content.

User-interface 30 may also include a section 36 that includes filters that allow a user to tailor his experience. Filters may allow a user to search for specific types of information, such as restaurant reviews. Filters may also include one or more map filters that allow a user to configure whether content should be influenced by his location and further allow user to define the geographic criteria for associating his location with content or offers. In some embodiments, filters may allow restaurants, bars, events, concerts, and shops to be located and relevant content related to these businesses to be displayed. In some embodiments, nonprofit organizations may benefit from filters, such as by allowing users to search for local organizations or related petitions or volunteer opportunities associated with the user's geographic location or interests.

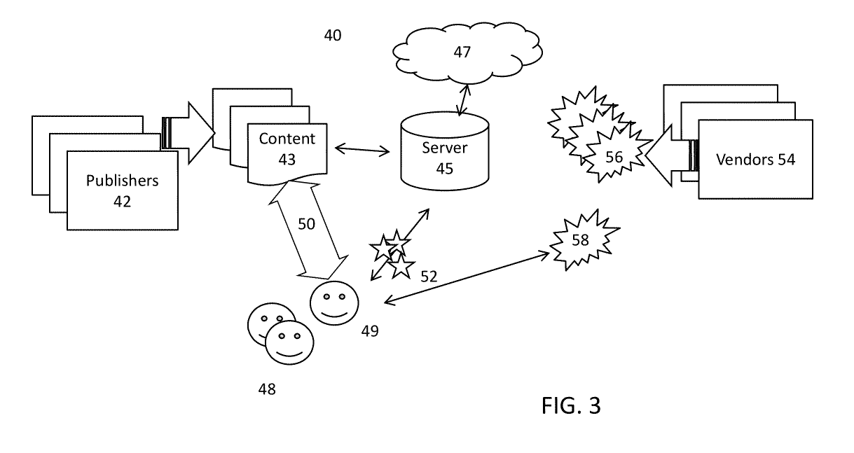

FIG. 3 shows an exemplary system 40 for publishing content and providing incentives for users to interact with content. System 40 allows publishers 42 to publish content 43 and deliver this content to users of system 40. Publishers 42 can be traditional websites, such as news organizations or blogs. Content 43 can include traditional online articles or blog entries that may be published by making these articles available on websites. Content 43 may be provided in such a form as RSS feeds that allow content aggregators to collect and organize content or links to content. A user database in server 45 can be maintained to identify user preferences to assist in selecting appropriate content to display to users 48. Server 45 may acquire information from configuration settings selected by users, the behavior of the users, or by syncing with social networking sites via network 47. Social networking sites often include APIs that allow third parties to have access to user preferences and personal information, such as status posts. These APIs allow users to provide login credentials to enable third parties to have restricted access to this information.

A user 49, selected from a group 48, can access system 40 through a computing device, such as a mobile computing device that is connected to a network. System 40 uses the preferences and information gathered from social networking sites pertaining to user 49 to identify criteria for selecting appropriate content to provide to user 49. User 49 can then view subsets of content 43 as appropriate based on his interests and preferences. These content items may be made available via an app on a tablet/mobile device or via a web interface that allows the user to log onto system 40. System 40 can utilize the RSS feeds and selection of appropriate content based on information in user database 45 to filter content from available RSS feeds and display this information to user 49 when he accesses the application or webpage associated with system 40. User 49 may log on and begin interacting with content items 43.

User 49 may interact with content via a user-interface 50 that may provide a wrapper to content 43. In some embodiments, this wrapper may provide a way of displaying content 43 while also providing a user interface that allows users to play games related to the content, such playing trivia games or sharing the content with other users, such as by clicking a “like” button. Based on the interaction with content 43, user 49 may be awarded points 52. Points 52 may be associated with user 49 in a user database in server 45. User 49 may then use system 40 to redeem these points for offers.

Vendors 54 may publish offers via system 40. These offers may be associated with point values that allow users to redeem points accrued by interacting with user-interface 50 when viewing content. User 49 may log onto system 40 and seek a list of available offers for which he may redeem his points. Vendors 54 may publish a group of offers 56. These offers may be generally available or may be filterable to tailor the offers to user 49. User 49 may then select an offer 58 and redeem his points. Server 45 may deduct the points from the user's account and may facilitate the delivery of coupons or goods related to the offer. System 40 may then notify the vendor that the transaction is complete so that the vendor can complete the transaction with user 49. In some embodiments, system 40 may maintain accounts for vendors 54 and may facilitate credit or cash payments to vendors for certain offers that have been redeemed.

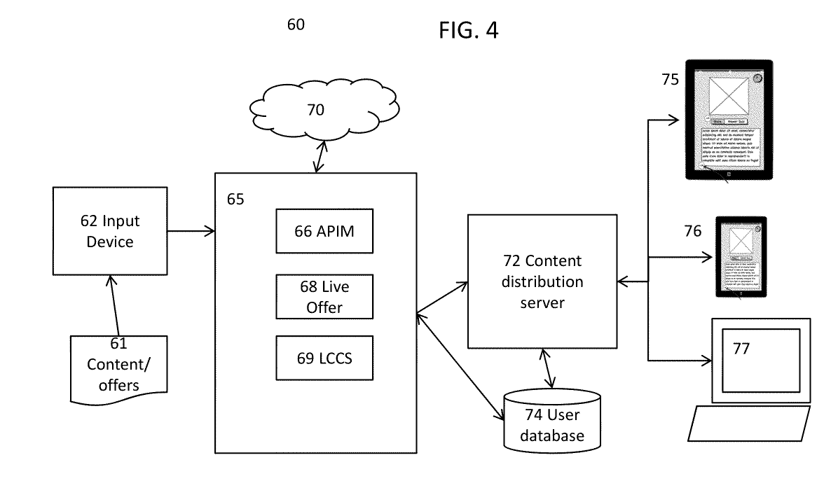

FIG. 4 shows an exemplary system for distributing content and offers to users. System 60 includes the server components that may be used to receive information about content and offers, process this information, and distribute this information to users. Content and offers can be received by the system via an input device 62. This may include a web portal that allows vendors to create offers using system 60 or may include network adapters that may be used to interact with external websites and gather content such as RSS feeds. Accordingly, input device 62 can be a computer accessing the web, a network adapter, a mobile device, etc., depending on the nature and scope of the content being input into system 60.

Content management system (CMS) 65 receives information about content or offers and processes this information using various components. CMS 65 may be a software framework operating on a server. CMS 65 works to target, categorize, and distribute content to users. A first component, API integration module (APIM) 66, can facilitate tying in with multiple APIs to gather and store data. These APIs may include APIs that interact with an RSS aggregator to retrieve content, including a plurality of articles or webpages. These APIs may also include APIs that allow access to user information and preferences via social networking sites. In some embodiments, APIM 66 is extensible, allowing additional APIs to be added, such as new APIs for new social networking sites or specific APIs for specific content providers. For example, a newspaper may provide an API to allow aggregators to access this content.

CMS 65 may also include a live offer module 68. Live offer module 68 includes a database that stores content, offers, coupons, and user information. Data about offers may include time-specific offers, which contain associated data that may relate to specific user preferences or location information. Live offer module 68 may include a custom interface to allow vendors to publish new offers and facilitate redeeming of offers via a web interface.

CMS 65 may also include a location-based content serving system (LCSS) 69. LCSS 69 may be a location aware system that draws data about a user's location. In some embodiments, LCSS 69 is primarily driven by user preferences and behavioral data. In some embodiments, LCSS 69 does not make use of a user's location. LCSS the may take advantage of APIs presented by APIM 66 to determine information about a user's location and his behavior. Live offer module 68 may work with LCCS module 69 to identify relevant offers to present to a user based on behavioral and location information.

Content distribution server 72 can be utilized to distribute content to individual users. Server 72 processes data from CMS 65 and distributes content to users and their devices. In some embodiments, server 72 monitors user behavior and delivers analytical information regarding site usage to CMS 65 to improve the identification of user preferences. CMS 65 may identify the individual users that should receive specific content based on user preferences or behavior. Content distribution server 72 may update user database 74 to reflect the behavioral information. Similarly, content distribution server 72 may utilize user database 74 to assist in determining which content to display to the individual users. In some embodiments, user database 74 is utilized by CMS 65 to associate users and content.

Content distribution server 72 may present contents to user devices 75, 76, and 77. User device 75 may include a mobile tablet device that includes an app or web browser that allows content distribution server 72 to present information to users. User device 76 includes a mobile phone which may also include a browser or app that allows distribution of content to users. User device 77 may include a laptop or desktop computer having a web browser or an application that may receive content from content distribution server 72.

An exemplary use case for system 60 includes publishing of content via RSS feeds. Input device 62 gathers content in the form of RSS feeds. These feeds may be presented to CMS 65 via APIM 66. The feed then populates the system according to specified category information. That is, CMS 65 may mine the content of the RSS feed, including reviewing tags or metadata or by applying natural language processing to the content items in the feed. User preferences, which may be maintained by user database 74 or by databases associated with CMS 65 may identify the categories of content the users are interested in. Based on the content of the RSS feed, content items (e.g. articles) from the RSS feed can be associated with the preferences of a given user. When a user logs on to the system, he may be presented with a subset of the content of an RSS feed based on his preferences. Server 72 may distribute this content to users based on the preferences or device type. In some embodiments, server 72 may distribute content to users in response to keyword searches by the user on his device. In some embodiments, server 72 monitors the behavioral patterns for each user when interacting with the content being served to gather additional insight into the user's preferences. This information can be relayed back to CMS 65 to assist in tailoring content in the future. Exemplary behavior that can be monitored can include identifying the types of content that a user spends the most time viewing, the content that has been saved for later viewing, the most frequent keywords searched by the user, etc.

Another exemplary use case of system 60 is publishing an offer to users. A vendor may utilize input device 62 to publish offers. This may include interacting with system 60 via a web portal. An offer can include an identification of category information, including the type of offer being made. This type of information may allow offers to be matched to user preferences. For example, an offer related to fashion may be placed in a fashion category. Users who are interested in fashion can then receive the offer. CMS 65 utilizes category information relating to an offer and identifies the appropriate users or criteria for finding users to present the offer. Server 72 then processes data about the offer and associated users and distributes the offers based on category type, specific users identified, or geo-location information about the offer. Users that select data based on keyword searches or who interact with system 60 on devices at certain locations can then be presented with the offer. In some embodiments, server 72 can monitor the behavior of users in interacting with each offer to provide feedback to the vendor or to refine user preferences for associating users with future offers.

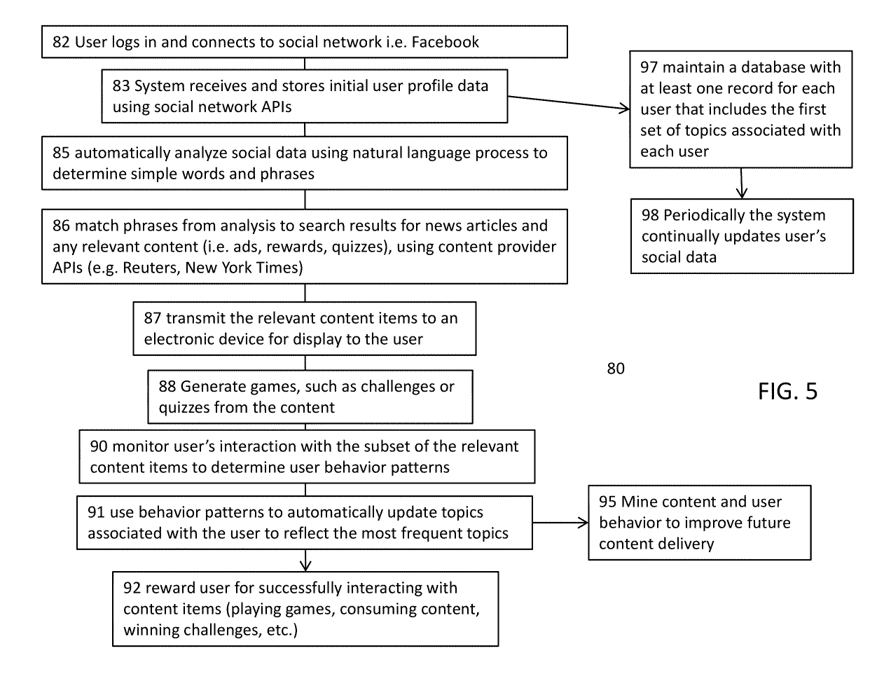

FIG. 5 shows an exemplary method 80 for distributing content to users and allowing those users to interact with the content while rewarding those users. Method 80 may be carried out by a server, such as server 45 shown in FIG. 3 or the server system shown in FIG. 4, which may include input device 62 CMS 65 and content distribution 72. It should be understood, that the systems described herein can be implemented as server-based systems on the network enabled machines that include a processor, memory, and other computational resources sufficient to serve content on the web. These systems may also include a cloud-based server infrastructures. The servers may include user profile databases which may include one or more records for each user that identify person definition records for each user to maintain a model of the topical interests of each user, the reward points, and any behavioral analysis of each user.

At step 82, a user logs into the content delivery and incentive system and provides credentials that allow the system to connect to social networks to which the user subscribes. For example, a user may grant the system permission to check his Facebook account. At step 83, the system uses APIs available from social networking sites to receive and store user profile information from the social networking sites. Information gathered may include the user's profile from the social networking site, which may include an explicit definition of his preferences, such as hobbies, interests, music and TV show preferences, books the user likes, etc. This profile information may also include user generated content, such as tweets or status updates. In some embodiments, the profile information may also include profile information of other individuals within the social circle of the user. For example, a user's friends may post information to their profiles, which may be available via a social network API. This may allow the system to gather a more complete picture of topics the user may be interested in. In some embodiments, the system also receives an explicit identification of topics that a user is interested in when the user first registers with the system.

At step 85, the system automatically analyzes the social data received from social networking sites using a natural language process to determine simple words and phrases contained in the social data. This may allow the system to determine a first set of topics that relate to the social media profiles of the user. For example, a user may refer in a status update to a band whose concert the user attended. Natural language analysis may reveal that the user has posted about the band. The user's interest in this band or this genre of music may be noted. In some embodiments, the step of automatically analyzing the profile information can include identifying frequently occurring words and profile. These frequently occurring words may be matched to a dictionary of topic categories to identify topic categories that may relate to the user's social networking profile information. This dictionary may adapt, as more feedback is received from users.

In some embodiments, each user has a person definition file or record in a database that identifies information about the user, including categories of topics that the user is interested. The population of the topical categories can be initially based on an explicit identification of topics selected by the user when he first registers with the system. The person definition records may be further updated by analyzing social networking data about the user, such as information posted on a user's wall, information tweeted by the user, information shared, or status updates of the user on a social networking site. This may allow the person definition record of each user to be a dynamic record that captures the user's interests beyond just those topics that the user explicitly selected. In some embodiments, the person definition record may also be updated based on behavioral analysis of the user while he interacts with the system. For example, the user may regularly choose to review articles about a certain topic when these articles are presented. The system may note the user's enthusiasm for the topic in his person definition record. This can allow the understanding of topics of interest to the user to grow and change as the user's interests grow or change.

At step 86, the system matches phrases from its analysis of the user social data (or topics related thereto, including any topics in the person definition record) to search results for news articles or other content items. These content items may include ads, rewards, quizzes, blog entries, or the like. In some embodiments, content providers, such as the New York Times, may provide APIs that allow the system to request or receive content. For example, some websites may present an API for RSS feeds to the system. In some embodiments, each content item can include topical information associated with the item. This information may be available through an API presented by the content provider. For example, articles may include tags or metadata that identify topics contained therein. In some embodiments, topical information can be gathered by applying natural language analysis to each content item. Users are matched with content items by matching a set of topics associated with a user to the set of topics associated with a set of content items to determine a relevant subset of content items that may be of interest to a user.

At step 87, a server then transmits the relevant content items to a user's electronic device, such as a mobile device, to allow content items to be displayed to a user. The content items may be presented to the user using any user interface, such as that shown in FIGS. 1 and 2. Transmission to a user's device may be done using any conventional means, such as sending information across the Internet, which may include sending items across a cellular network to a mobile device.

At step 88, a server may generate games such as challenges and quizzes, from the content. In some embodiments, quizzes or games may be user-generated. For example, a publisher of an article may also publish questions related to the content, designed to encourage reading comprehension. Similarly, users who review an article may create their own quiz questions related to the content and be rewarded for the creation of the quiz. Subsequent users accessing the content item may answer the quiz questions and be also rewarded with points. In this manner, game content related to content items may be organically derived from user-generated content. In some embodiments, incentives, such as reward points, are provided for generation of game content such as quiz questions related content items.

At step 90, the server or an app on a user's device may monitor the user's interaction with the subset of relevant content items that have been served to the user. This may allow the system to determine user behavior patterns. For example, the system may note which items a user most frequently views. This information can be useful in empirically determining which content topics the user is most interested in.

At step 91, user behavior patterns can be used to automatically update the topics associated with the user in a user's person definition record to reflect the most frequently accessed topics for that user. In this manner, a person definition record may include information gathered from configuration by the user, his social networking profiles, as well as the actual content he consumes. In some embodiments, at step 95 the content consumed by a user and his user behavior can be mined to improve future content delivery. This may be an automatic step completed by a server or an app or a combination of the two.

At step 92, users may be automatically rewarded for successfully interacting with content items. For example, a user may be rewarded with a certain point value for reading an article. Similarly, a user may be rewarded with another point value for answering questions about an article. Similarly, a user may be rewarded with another point value for sharing an article on a social networking website. This can encourage users to disseminate articles to their friends, increasing the overall distribution of content items. Upon completion of an interaction, the user's person definition file or other records associated with the user may be updated to reflect the users point balance. This point balance may then be used to purchase virtual or real world goods or services, such as coupons.

A server may also maintain a database of the user's interests. At step 97, a server maintains a database with at least one record for each user that includes the first set of topics associated with each user. This set of topics may be gathered from manual configuration when a user signs up to use the system, as well as by processing profile data from social networks. At step 98, the server may continually update a user's social data by periodically accessing a user's social network profiles. This may occur on a regular time interval, even when the user is not logged into the system. In some embodiments, this may occur only when a user logs on to the system.

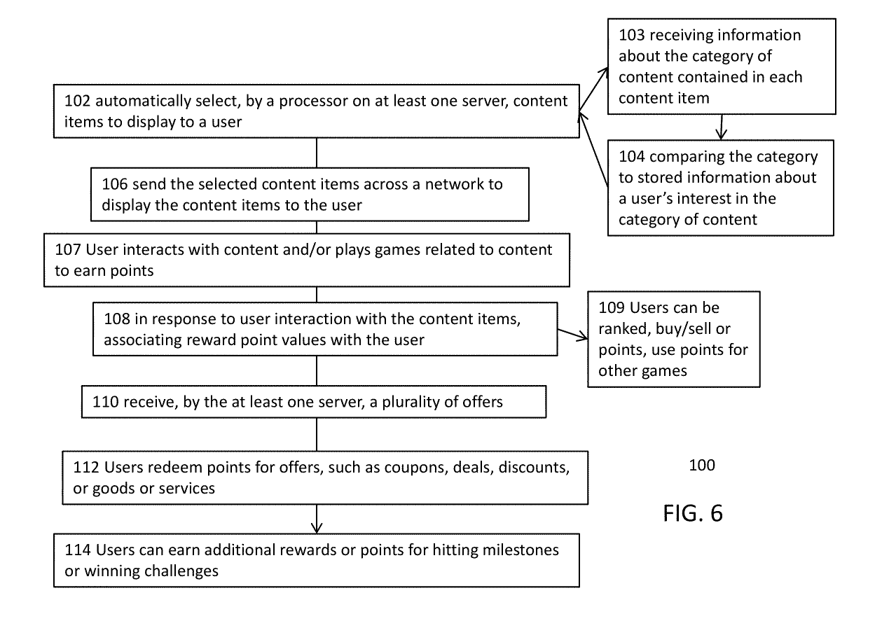

FIG. 6 shows another method 100 by which a system may serve content to a user and reward him for certain interactions with the content. Method 100 may be performed by a server. In some embodiments, method 100 may be performed with the assistance of an app on a user's electronic device.

At step 102, at least one processor on at least one server automatically selects content items to display to a user. The method by which content items are selected may include any methods described throughout, including those methods described with respect to FIG. 5. In some embodiments, the selection of content may include steps 103 and 104. At step 103, a server receives information about the category of content contained in each content item. This can include receiving keywords or metadata associated with items in an RSS feed or may include receiving information mined from the content item by a software process that applies natural processing to any words in each content item. For example, a news article can be mined to identify locations, individuals, or information about the type of events described. The software process may maintain records associated with each content item that includes the topical information. In some embodiments, users may review content items and tag the content items with certain topical tags. These tags may then be used to identify suspected content categories in the content item. In some embodiments, users may be rewarded with points for tagging content items with topical categories. In some embodiments, points are rewarded to users only upon confirmation by other users that the topical tags are correct.

At step 104, a processor on the server compares the category information of each content item to stored information about a user's interest in a category of content. In some embodiments, the stored information about a user's interest is generated by applying natural language processing to a user's profile information from at least one social networking website. In some embodiments, the social networking website may include Facebook or Twitter. Profile information can include a user's Facebook profile and any posts the user makes on Facebook. In some embodiments, the stored information may be generated by applying natural language processing to posts and profile information of other users associated with the user. For example, the server may process posts made by individuals that a user follows or who are in a user's circle of friends. In some embodiments, the identification of users that share a common social circle can be determined by reviewing profile information available on social networking websites. For example, Facebook may make a list of a user's friends available to the server via an API.

At step 106, the server sends selected content items across the network to display the content items to the user. This may include making content items available to a user when he logged into the system or opens an app on a mobile device that connects to the server.

At step 107, the user interacts with the content on his device. This can include playing games related to the content, playing trivia related to the content, reviewing the content, sharing of the content on social networking websites, etc. In response, at step 108, the user may be rewarded for his interaction by providing reward points. These reward points may be associated with the user by updating a reward point balance on the user's account or in a user's person definition record in a database. In some embodiments, at step 109, users can be ranked by their accumulated rewards points. Users may also be allowed to buy or sell reward points, including using rewards points in an auction. In some embodiments, users may also use reward points to play other games. For example, users may be allowed to use their reward points in casino style games or virtual board-game-style games.

At step 110, the server receives a plurality of offers. These offers may be received from a database or directly from vendors over the Internet. At step 112 users may redeem their reward points for these offers. Users may receive coupons, deals, discounts, goods, or services. In some embodiments, these rewards may be real-world rewards. In some embodiments, these rewards may include virtual items, such as artwork or avatar items.

In some embodiments, at step 114, users may earn additional bonus reward points or rewards for hitting milestones or winning certain challenges. For example, a user may be rewarded with a coupon for a free cup of coffee when he has reviewed 100 news articles.

In some embodiments, the systems described herein can be used for educational purposes. Much the same way that restaurants have offered free pizza or pizza parties to grade school students when their teachers identify students that have completed a certain number of book reports, the systems described herein can reward students. For example, content items may include items related to homework assignments. Students may be incentivized to comprehend the content by providing students with reward points that may be redeemable for goods and services desirable to those students. This may provide incentives beyond achieving good grades to motivate students to read more. In some embodiments, the user action that results in rewards may include submission of essays related to each content item.

In some embodiments, there are four primary components to a content delivery and incentive system: Points, Content Channels, Check-in Aggregator, and Store. The architecture can scale and easily integrate new features over time. Below is a description of each component and core functionality, according to some embodiments.

Points: The system can be a game for exploring the web and world around users. Users can earn points for sharing articles, checking-in to favorite locations and even setting up a profile. Users can to earn points for specific actions and interactions within the network. Examples of “specified interactions” for points can be, but are not limited to: initial creation of user profile; sharing of content via social media outlets (i.e., Facebook); checking into local venues via location based social networks (i.e., Foursquare); sharing deals found in the system store via social media outlets/networks.

Content Channels: The system can feature content from publishers and websites. The system can display partner RSS feeds in a beautiful, simple layout in its respective channel. Channels can include Tech, News, Politics, Sports, Music, Cooking, Entertainment, Health, Fashion, Causes and Photos, or the like. Users can also create custom channels with feeds of their choice. Users can earn points when they share content on social networks. Advertisers can target a specific user set within channels via in-feed advertisements and/or channel sponsorship.

Exemplary use cases for Content Channels:
Publisher (Syndication of Content/RSS Feeds): Syndication of Content/Source via system Network Specified Feed.
Users (System Member): Discovery of Content (News/Published) through customizable content aggregator.
Advertiser (In-Feed Banner Ad Client): Promotion via in-feed banner advertisement. Personal customization of campaign.
Advertiser (Channel Sponsorship): Promotion via channel sponsorship.

Check-in Aggregator: Users can receive nearby check-in offers from Yelp, Foursquare, Gowalla and Facebook and other location-based services. Users can check-in or share an offer from location-based networks and earn points. Merchants can promote check-in offers via pre-existing location based services. Merchants can also create a customized system check-in offer.

Exemplary User Cases of a Check-in Aggregator:
Users (System Network Member): Discovery of location-based offerings via customizable content aggregator.
Merchant (General Check-in offer) System can allow promotion of check-In offers.
Merchant (Top Listing Check-in offer) System can allow promotion through top-line listing keyword search.
Merchant (Exclusive System Check-In Deal/Offering) System can allow promotion of deal through customizable System offering.

System Store (Cost Per Redemption): Users can spend Points for a variety of items in the Store. Offers can include deals to local spots, concert tickets, magazine subscriptions and much more in the System Store. Users can share interesting offers with friends for additional points. The System can allow an Advertiser to set a limit for each item, so once the product is “sold out”, the user can wait until a new offer becomes available and can receive notifications.

Exemplary use cases of a System Store:
Advertiser (CPR Client): Promotion of customized deal through System Store.
User (System Network Member): Can redeem Points for offerings within System Store.
Subscriptions: 500 points for a 3 month subscription to Spin Magazine, 200 available
Downloads (content, services i.e. Netflix, app download): 250 points for an Angry Birds Pro download, 200 available
Discounts (travel, hospitality, transportation, groceries): 10,000 points for 50% off a Carnival Cruise, 25 available; 250 points for 40% off any purchase of $50 or more at Kroger, 100 available

Further features of some embodiments may include any subset of the following. Some embodiments may include a platform of social entertainment and economic stimulation. Some embodiments may be able to be a part of the everyday human experience by rewarding people for their inherent needs by recognizing their behaviors. Some embodiments can be where brands, businesses and consumers meet.

Some embodiments may include an application that can provide: decision making knowledge (influence through social/interactive map); social interactivity; content aggregation (location based and opt-in); customizable interface display; loyalty points system for physical and digital interaction; paradigmatic tool for users, brands and businesses; a portal of focused content based on user preferences; distribution platform of content from partners, delivered in real time; incentives for influential behavior; 3D interactive map with customizable layers of content that can be toggled on/off based on viewing preferences

It should be appreciated that any of the software components described herein can operate on one or more processors on one or more computing devices. Software instructions disclosed herein can be stored on non-transitory computer readable media, such as optical or magnetic disks, memory such as flash memory or RAM, cache memory, buffer memory, or the like. Instructions may also be distributed via a network. It should be further appreciated that the instructions may be organized into modules and different processors can execute different modules. Different modules may be stored on different devices, which may be understood as part of the same computer readable memory.

The present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims covered be construed to all such equivalent variations as fall within the true spirit and scope of the invention.

What is claimed is:

1. A method of incentivizing user consumption of content in an online environment, comprising steps of:
automatically selecting, by a processor on at least one server, content items to display to a user;
sending the selected content items across a network to display the content items to the user;
in response to user interaction with the content items, associating reward point values with the user on the at least one server;
receiving, by the at least one server, a plurality of offers;
allowing a user to redeem reward point values for incentives identified by at least one of the plurality of offers.

2. The method of claim 1, wherein the step of automatically selecting content items comprising steps of:
receiving information about the category of content contained in each content item at the at least one server; and
comparing the category to stored information about a user's interest in the category of content.

3. The method of claim 2, further comprising generating the stored information about a user's interest by applying natural language processing to a user's profile information on at least one social networking website.

4. The method of claim 3, wherein the social networking website is Facebook and the profile information comprises at least one of the user's Facebook profile and the user's posts to Facebook.

5. The method of claim 2, further comprising generating the stored information about a user's interest by applying natural language processing to profile information from at least one social networking website, wherein the profile information includes at least one of posts and profile information of other users associated with the user.

6. The method of claim 2, wherein the other users share a social circle with the user, as determined by the profile information.

7. The method of claim 1, wherein the user interaction comprises sharing at least one content item using a social networking website.

8. The method of claim 1, wherein the user interaction comprises playing a game related to the content of at least one content item.

9. The method of claim 8, wherein the game comprises a trivia game that poses questions to the user to determine his comprehension of the content.

10. A method for distributing content to a user, comprising:
receiving, at a server, profile information relating to at least one user, wherein the profile information contains information related to at least one social media profile of the user;
automatically analyzing the profile information using natural language processing to determine a first set of topics that relate to the at least one social media profile of the user;
matching, at the server, the first set of topics to a second set of topics associated with a set of content items to determine a set of relevant content items;
transmitting at least a subset of the relevant content items to an electronic device for display to the user; and
automatically rewarding the user for select interactions with the subset of the relevant content items in the form or redeemable reward points.

11. The method of claim 10, wherein the profile information contains information related to at least one social media profile of the other users in a social circle with the user.

12. The method of claim 10, wherein the step of automatically analyzing the profile information includes identifying frequently occurring words in the profile information that is associated with topical categories.

13. The method of claim 10, further comprising maintaining a database with at least one record for each user that includes the first set of topics associated with each user.

14. The method of claim 10, further comprising:
monitoring the user's interaction with the subset of the relevant content items to determine user behavior patterns; and
using the behavior patterns to automatically update the first set of topics associated with the user to reflect the topics that the user interacts with the most.

15. A non-transitory computer-readable media, comprising instructions to configure a processor on a server to perform the following steps:
receiving, at the server, profile information relating to at least one user, wherein the profile information contains information related to at least one social media profile of the user;
automatically analyzing the profile information using natural language processing to determine a first set of topics that relate to the at least one social media profile of the user;
matching, at the server, the first set of topics to a second set of topics associated with a set of content items to determine a set of relevant content items;
transmitting at least a subset of the relevant content items to an electronic device for display to the user; and
automatically rewarding the user for select interactions with the subset of the relevant content items in the form or redeemable reward points.

16. The non-transitory computer-readable media of claim 15, wherein the profile information contains information related to at least one social media profile of the other users in a social circle with the user.

17. The non-transitory computer-readable media of claim 15, wherein the step of automatically analyzing the profile information includes identifying frequently occurring words is the profile information that is associated with topical categories.

18. The non-transitory computer-readable media of claim 15, further comprising instructions for maintaining a database with at least one record for each user that includes the first set of topics associated with each user.

19. The non-transitory computer-readable media of claim 15, further comprising instructions for:
monitoring the user's interaction with the subset of the relevant content items to determine user behavior patterns; and
using the behavior patterns to automatically update the first set of topics associated with the user to reflect the topics that the user interacts with the most.
